(19) United States
(12) Patent Application Publication
(10) Pub. No.: US 2026/0316325 A1
(43) Pub. Date: Oct. 15, 2026

(54) MULTI-PANEL QUEUEING AND SQUARING TABLE FOR MANUFACTURING WALL PANELS

(71) Applicant: 16543171 Canada Ltd., Oak Bluff (CA)

(72) Inventors: Kenneth Ross Parson, Winnipeg (CA); Kostiantyn Kachkalda, Oak Bluff (CA)

(73) Assignee: 16543171 Canada Ltd., Oak Bluff (CA)

(21) Appl. No.: 19/551,340

(22) Filed: Feb. 26, 2026

Related U.S. Application Data
(60) Provisional application No. 63/785,911, filed on Apr. 9, 2025.

(51) Int. Cl. B27M 3/00; B27F 7/00; B65G 41/00; B65G 47/82

(52) U.S. Cl. CPC B27M 3/0073; B65G 41/003; B65G 47/82; B27F 7/003; B65G 2201/022

(57) ABSTRACT

A squaring table comprises: opposite first and second conveyor assemblies for supporting and conveying each wall panel and a length tracking system. Each conveyor assembly comprises a conveyor, exit clamps and a plurality of segmented lifts, and the first conveyor assembly further includes a plurality of segmented clamps. The exit clamps work together to move a first wall panel against the end stops to square the wall panel. The length tracking system determines the length of the first wall panel and communicates the length to a controller. The controller engages a contiguous subset of the plurality of segmented clamps and segmented lifts to clamp and elevate the first wall panel away from the first and second conveyors. The first and second conveyors advance one or more additional wall panels onto the squaring table while the first wall panel is elevated away from the first and second conveyors by the lifts.

### CROSS-REFERENCE TO RELATED APPLICATIONS

This United States patent application claims priority to U.S. Provisional Patent Application No. 63/785,911 filed on Apr. 9, 2025, which is incorporated herein in its entirety by reference.

### FIELD

The subject matter of the present disclosure relates to systems for manufacturing pre-fabricated structures for use in the construction industry; in particular, the present disclosure relates to queueing and squaring tables used in manufacturing pre-fabricated wall panels.

### BACKGROUND

In the construction industry, pre-fabricated components of a structure, such as wood-framed wall panels, roof trusses, floor panels or cassettes, and the like, may be manufactured in a facility and then delivered to a construction site. The use of such pre-fabricated components may increase efficiency, reduce waste and reduce the amount of time it takes to complete construction on a building.

A typical manufacturing line for manufacturing wood-framed wall panels may include a cutting station for cutting the lumber to measured lengths for studs, plates and headers, a framing station for assembling the frame, and a sheathing station for fastening plywood (or other sheathing) onto the assembled frame. At both the framing station and the sheathing station, there may be a squaring mechanism for confirming that the wall panel frame is square, prior to fastening the studs to the frame (at the framing station), or prior to fastening the sheathing to the frame (at the sheathing station). The squaring mechanism may typically include stops for halting all portions of the frame, an actuator for moving all the frame components against the stops, and clamps for holding the frame in place once it has been squared. Each station accepts one wall panel at a time. There may be additional stations in the manufacturing line, such as a station for cutting out and framing up window or door openings in the wood panel, or for installing insulation within the wall panel. The stations may be positioned sequentially, and may have a conveyor moving the wall panels from one station to the next station.

On a typical manufacturing line, there may be a need to manufacture wall panels of varying lengths. Wall panel lengths may range, for example, between two feet and more than forty feet. When a plurality of wall panels, of varying lengths, are manufactured at the same time, there may be a bottleneck created at a given station, as a result of a manufacturing step taking longer to complete on a longer wall panel, as compared to performing the same manufacturing step on a shorter wall panel. For example, it will be appreciated that it takes longer to fasten sheathing to a twenty-foot panel than to fasten sheathing to a six-foot panel. When one or more shorter wall panels follow a longer wall panel, this may result in holding up the manufacturing line at several stations upstream of the sheathing station, while the sheathing procedure is performed on the longer wall panel.

Typically, the issue of having to queue up several wall panels behind a given station in a manufacturing line is addressed by introducing longer conveyors in-between the stations, providing room on the conveyor for two or more wall panels to queue up behind a given manufacturing station. However, this solution requires a larger footprint for the overall manufacturing line, and may also require the purchase of additional conveyors. Another way of addressing this issue is to use cranes, robotic arms or manual labour to temporarily remove the panels from the manufacturing line; however, this solution may require additional time, equipment and/or labour to implement.

### SUMMARY

In one aspect of the present disclosure, a segmented clamping system may be provided for individually handling and manipulating two or more wall panels that are on the same table or station in the manufacturing line. By utilizing multiple, spaced-apart clamps to temporarily hold the frame in place while a manufacturing step is performed, the system may be configured so that only one panel is being clamped and worked upon, while additional wall panels that are on the same table and adjacent to the clamped panel, remain unclamped. Additionally, a segmented lifting system may be provided for temporarily lifting and supporting a panel being worked upon, so that the panel is cleared from the conveyor. By temporarily lifting the panel being worked upon from the conveyor, the conveyor may continue to bring forward additional panels that are upstream of the panel being worked upon, but without acting on the panel being worked upon. By configuring the lift system to be a segmented lifting system, the lifting system may only lift up the panel being worked upon while not affecting the other panels that are upstream of the panel being worked upon.

In some aspects of the present disclosure, a table for squaring a wall panel and for queueing a plurality of wall panels at a manufacturing station is provided. Each wall panel of the plurality of wall panels comprises an upper plate, a lower plate, a plurality of studs extending between the said upper and lower plates and a sheathing. The table comprises: opposite first and second spaced apart conveyor assemblies for conveying each wall panel of the plurality of wall panels, the first and second conveyor assemblies defining an entrance end and an opposite exit end of the table; the first conveyor assembly comprising a first conveyor, a first exit clamp located at the exit end of the table, a plurality of segmented clamps and a first plurality of segmented lifts; the second conveyor assembly comprising a second conveyor, a second exit clamp located at the exit end of the table and a second plurality of segmented lifts; a length tracking system for tracking a length of each wall panel of the plurality of wall panels passing through the table; a pair of end stops located at the exit end of the table; a controller in communication with the first and second conveyors, the first and second exit clamps, the plurality of segmented clamps, the first and second plurality of segmented lifts, the length tracking system and the pair of end stops. The first and second exit clamps cooperate with the controller to initially clamp a first wall panel of the plurality of wall panels and move the first wall panel against the pair of end stops to square the first wall panel. The controller and the length tracking system determine a length of the first wall panel, and the controller engages only a corresponding contiguous subset of clamps of the plurality of segmented clamps to clamp the length of the first wall panel and engages only a corresponding contiguous first subset of lifts of the first and second pluralities of segmented lifts to elevate the length of the first wall panel above the first and second conveyors so that the first wall panel is not in contact with the first and second conveyors. The first and second conveyors advance one or more subsequent wall panels of the plurality of wall panels onto the table when the first wall panel is elevated above the first and second conveyors.

In certain embodiments of the table, one conveyor assembly of the first and second conveyor assemblies is slidably mounted to a rail, the rail located perpendicular to the first and second conveyors, and wherein the one conveyor assembly may be selectively repositioned relative to the other conveyor assembly so as to configure a width of the table for conveying wall panels of different heights.

In some embodiments, the table further comprises a central support located between and parallel to the first and second conveyor assemblies, the central support comprising a third plurality of segmented lifts, wherein the controller engages only a corresponding contiguous second subset of lifts of the third plurality of segmented lifts, corresponding to the first subset of lifts, to support and elevate a central portion of the first wall panel.

In certain embodiments, the central support of the table is slidably mounted to a rail, the rail located perpendicular to the central support, and wherein the central support may be selectively repositioned relative to the first and second conveyor assemblies so as to configure the position of the central support relative to the first wall panel.

In certain embodiments of the table, a manufacturing step is performed on the first wall panel when the first wall panel is elevated above the first and second conveyors.

In certain embodiments, the first and second exit clamps each comprise a longitudinal actuator for moving the exit clamp and the first wall panel in a longitudinal direction against the pair of end stops, and a lateral actuator for moving the first exit clamp and the first wall panel in a lateral direction towards and against a fence, the fence adjacent to the second conveyor.

In some embodiments, each of the first and second exit clamps includes a pressure regulator, each pressure regulator for regulating a pressure applied to the first wall panel by the corresponding exit clamp when the first exit clamp utilizes the lateral actuator to move the first wall panel against the fence.

In some embodiments, each end stop of the pair of end stops includes integrated sensors integrated into each end stop, the integrated sensors for detecting that the first wall panel is pushed against both end stops of the pair of end stops.

In certain embodiments, the length tracking system is a sensor. In certain embodiments, the sensor is an entrance sensor is located at the entrance end of the table. In some embodiments, the sensor is selected from a group comprising: laser sensors, photoelectric sensors, encoders, ultrasonic sensors, vision sensors, inductive sensors, capacitive sensors. In some embodiments, the sensor comprises a plurality of sensors, the plurality of sensors positioned spaced apart from one another along, and adjacent to, at least one conveyor of the first and second conveyors, and wherein the controller determines the length of each wall panel by detecting a presence or absence of each wall panel by each sensor and determining the time and speed of travel of each wall panel conveyed by the first and second conveyors. In some embodiments, the table wherein the length tracking system is a user input into the controller, the user input comprising a length of each wall panel and a sequence of each wall panel of the plurality of wall panels to be passed through the table.

In certain embodiments of the table, the entrance sensor detects a subsequent wall panel and the controller indicates there is an available space on the table. The first and second conveyors are activated by the controller to convey the subsequent wall panel onto the table until the subsequent wall panel is adjacent to an elevated pair of segmented lifts of the first subset of lifts; and wherein the length determining means determines the length of the subsequent wall panel and the controller engages only a corresponding contiguous second subset of clamps of the plurality of segmented clamps to clamp the length of the subsequent wall panel and engages only a corresponding contiguous second subset of lifts of the first and second pluralities of segmented lifts to elevate the subsequent wall panel above the first and second conveyors so that the subsequent wall panel is not in contact with the first and second conveyors.

In certain embodiments, a method of queueing a plurality of wall panels on a wall panel assembly line is provided. The wall panel assembly line comprises a queueing table and at least one of an upstream apparatus located upstream of the queueing table and a downstream apparatus located downstream of the queueing table. The method comprises: receiving a first wall panel on the queueing table, the queueing table comprising opposite first and second spaced apart conveyor assemblies for conveying each wall panel of the plurality of wall panels, the first and second conveyor assemblies defining an entrance end and an opposite exit end of the queueing table; the first conveyor assembly comprising a first conveyor, a first exit clamp located at the exit end of the queueing table, a plurality of segmented clamps and a first plurality of segmented lifts; the second conveyor assembly comprising a second conveyor, a second exit clamp located at the exit end of the queueing table and a second plurality of segmented lifts; a length tracking system for tracking a length of each wall panel of the plurality of wall panels passing through the queueing table; a pair of end stops located at the exit end of the queueing table; a controller in communication with the first and second conveyors, the first and second exit clamps, the plurality of segmented clamps, the first and second plurality of segmented lifts, the length tracking system and the pair of end stops. The first and second conveyors are actuated to convey the first wall panel towards, so as to abut against, the pair of end stops. The length of the first wall panel is determined by the length tracking system and the controller. The controller engages only a corresponding contiguous subset of clamps of the plurality of segmented clamps to clamp the length of the first wall panel and only a corresponding contiguous first subset of lifts of the first and second pluralities of segmented lifts to elevate the length of the first wall panel above the first and second conveyors so that the first wall panel is not in contact with the first and second conveyors. The controller determines whether there is space available on the queueing table to receive a subsequent wall panel from the upstream apparatus, and if there is space available on the queueing table, the controller actuates the first and second conveyors to convey the subsequent wall panel received from the upstream apparatus towards the elevated first wall panel until the subsequent wall panel is adjacent to a pair of elevated segmented lifts of the first subset of lifts.

In certain embodiments of the method, the upstream apparatus is an upstream conveyor in communication with the controller. When the first and second conveyors of the queueing table are actuated to convey the subsequent wall panel towards the elevated first wall panel, the upstream conveyor is also actuated to convey any wall panels of the plurality of wall panels supported on the upstream conveyor towards the queueing table.

In some embodiments, the method comprises performing a manufacturing step on the first wall panel when the first wall panel is elevated above the first and second conveyors.

In certain embodiments of the method, when the manufacturing step is completed on the first wall panel, the controller actuates the first subset of lifts to lower the elevated first wall panel onto the first and second conveyors; disengages the first and second exit clamps and the subset of segmented clamps from the first wall panel; retracts the pair of end stops away from the exit end of the queueing table; actuates the first and second conveyors of the queueing table to convey the first wall panel onto the downstream apparatus and convey any subsequent wall panels towards the pair of end stops; actuates the pair of end stops into place at the exit end of the queueing table so that the next subsequent wall panel is conveyed towards the pair of end stops until it abuts against the pair of end stops.

In certain embodiments of the method, the downstream apparatus is a downstream conveyor in communication with the controller. When the first and second conveyors of the queueing table are actuated to convey the first wall panel onto the downstream conveyor, the downstream conveyor is also actuated to convey the first wall panel received from the queueing table onto the downstream conveyor.

In another aspect of the present disclosure, a queueing table for queueing a plurality of wall panels at a manufacturing station is provided. Each wall panel of the plurality of wall panels comprises an upper plate, a lower plate and a plurality of studs extending between the said upper and lower plates and a sheathing. The queueing table comprises opposite first and second spaced apart conveyor assemblies for conveying each wall panel of the plurality of wall panels, the first and second conveyor assemblies defining an entrance end and an opposite exit end of the queueing table; the first conveyor assembly comprises a first conveyor, a plurality of segmented clamps and a first plurality of segmented lifts; the second conveyor assembly comprises a second conveyor and a second plurality of segmented lifts. The queueing table further comprises a length tracking system for tracking a length of each wall panel of the plurality of wall panels passing through the queueing table; a pair of end stops located at the exit end of the queueing table; a controller in communication with the first and second conveyors, the plurality of segmented clamps, the first and second pluralities of segmented lifts, the length tracking system and the pair of end stops. The controller and the length tracking system determine a length of a first wall panel of the plurality of wall panels, and the controller engages only a corresponding contiguous subset of clamps of the plurality of segmented clamps to clamp the length of the first wall panel and engages only a corresponding contiguous first subset of lifts of the first and second pluralities of segmented lifts to elevate the length of the first wall panel above the first and second conveyors so that the first wall panel is not in contact with the first and second conveyors. The first and second conveyors advance one or more subsequent wall panels of the plurality of wall panels onto the queueing table when the first wall panel is elevated above the first and second conveyors.

In another aspect of the present disclosure, a squaring table for squaring a wall panel at a manufacturing station is provided. Each wall panel of the plurality of wall panels comprises an upper plate, a lower plate and a plurality of studs extending between the said upper and lower plates and a sheathing. The squaring table comprises: first and second spaced apart conveyor assemblies defining an entrance end and an exit end of the squaring table; the first conveyor assembly comprising a first conveyor; the second conveyor assembly comprising a second conveyor; a pair of end stops located at the exit end of the squaring table; a sensor located at the exit end of the squaring table for detecting the presence of the squaring table against each end stop of the pair of end stops; a controller in communication with the first and second conveyors, the sensor and the pair of end stops. When the sensor detects a presence of a first wall panel of the plurality of wall panels, the first and second conveyors continue conveying the wall panel so as to engage the wall panel against both end stops of the pair of end stops so as to square the first wall panel.

In certain embodiments, the squaring table further comprises a first exit clamp of the first conveyor assembly and a second exit clamp of the second conveyor assembly, the first and second exit clamps located at the exit end of the squaring table. When the wall panel is abutting against both the end stops of the pair of end stops, the first and second exit clamps clamp the wall panel while a manufacturing step is performed on the wall panel.

In some embodiments of the squaring table, the first and second exit clamps each comprise a longitudinal actuator for moving the exit clamp and the first wall panel in a longitudinal direction against the pair of end stops, and a lateral actuator for moving the first exit clamp and the first wall panel in a lateral direction towards and against a fence, the fence adjacent to the second conveyor.

In certain embodiments of the squaring table, each of the first and second exit clamps includes a pressure regulator, each pressure regulator for regulating a pressure applied to the first wall panel by the corresponding exit clamp when the first exit clamp utilizes the lateral actuator to move the first wall panel against the fence.

In certain embodiments of the squaring table, the sensor is selected from a group comprising: one or more exit sensors located adjacent to the pair of end stops, integrated sensors integrated into each end stop.

### BRIEF DESCRIPTION OF THE DRAWINGS

FIG. 1 is a perspective view of a wall panel manufacturing line featuring embodiments of a queueing and squaring table in accordance with the present disclosure.

FIG. 2 is a top plan view of an embodiment of a queueing and squaring table in accordance with the present disclosure.

FIG. 3 is a perspective view of the queueing and squaring table shown in FIG. 2, with the conveyor assembly in the foreground having a plurality of clamps.

FIG. 4 is a close-up perspective view of a portion of the queueing and squaring table shown in FIG. 2, with the conveyor assembly in the foreground having a pair of exit clamps.

FIG. 5 is a close-up perspective view of the entrance of the queueing and squaring table shown in FIG. 2, showing the conveyor assembly having a pair of exit clamps.

FIG. 6 is a close-up perspective view of the exit of the queueing and squaring table shown in FIG. 2, showing the conveyor assembly having a pair of exit clamps.

FIG. 7 is a close-up perspective view of the exit of the queueing and squaring table shown in FIG. 2, showing the conveyor assembly having a plurality of clamps.

FIG. 8 is a close-up perspective view of the exit of the queueing and squaring table shown in FIG. 2, showing the conveyor assembly having the plurality of clamps from the opposite side of the conveyor assembly shown in FIG. 7.

### DETAILED DESCRIPTION

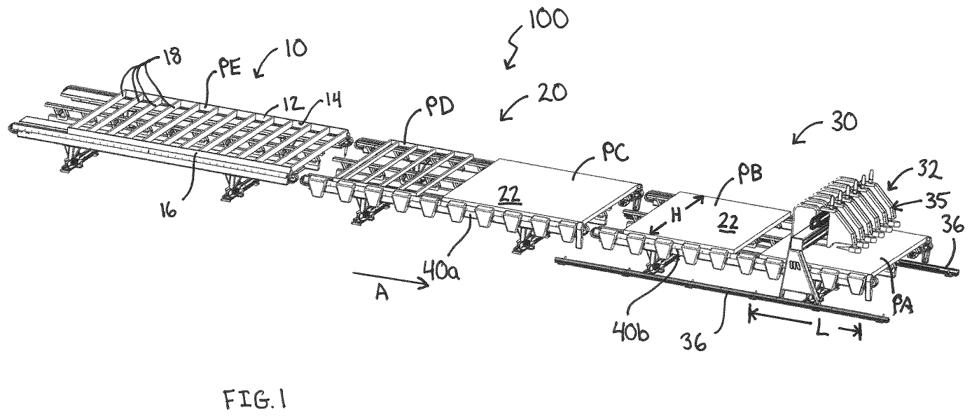

A section of a manufacturing line 100 (as shown in FIG. 1) may include a framing station 10, a tacking station 20, and a sheathing station 30. At the framing station 10, the frame 12 of the wall panel is constructed, comprising a pair of horizontal plates 14, 16, and a plurality of vertical studs 18 extending between the plates 14, 16. Once the wall panel frame 12 is constructed, conveyors move the frame 12 to a tacking station 20. At the tacking station 20, a sheathing 22 is temporarily tacked onto the frame 12 of the wall panel, using a plurality of fasteners. The sheathing 22 may be plywood, or any other suitable material for covering the frame 12 of the wall panel.

Once the sheathing 22 is temporarily tacked onto the frame 12, at the tacking station 20, conveyors move the wall panel onto the sheathing station 30. At the sheathing station 30, the tacked-oh sheathing 22 is now permanently fastened into place, typically with a plurality of nails or screws that securely fasten the sheathing 22 to the studs 18 of the wall panel. This manufacturing step may typically be accomplished by a sheathing gantry 32. The sheathing gantry 32 may be mounted to a pair of rails 36 for moving the gantry 32 along the length L of the wall panel. At each of the stations described above, the manufacturing step performed at each station may be automated, manual, or a combination of these. Typically, many wall panel manufacturing lines will automate most of the manufacturing steps described herein.

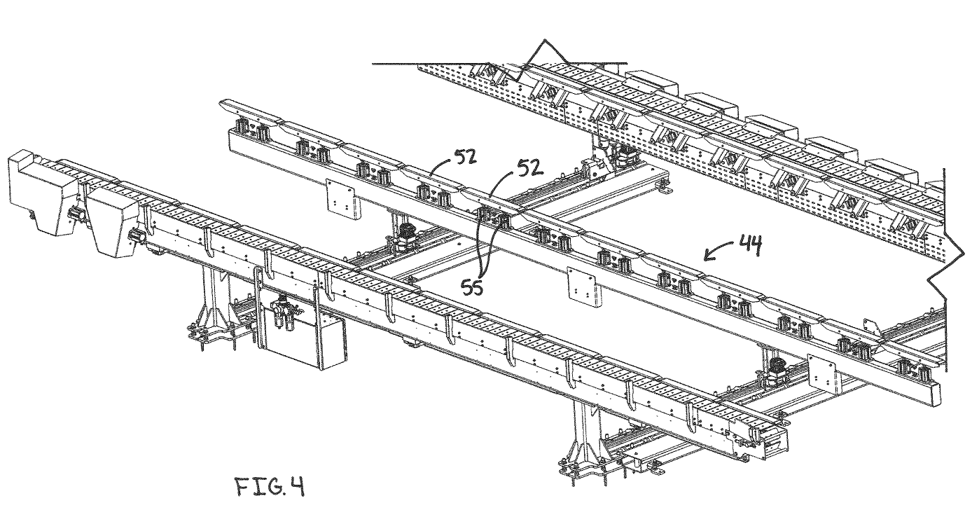

At the tacking station 20 and the sheathing station 30, a squaring mechanism may be used to confirm that the wall panel frame 12 is square before the sheathing 22 is fastened to the frame. If the frame 12 is skewed (in other words, if the plates and studs are not at right angles with respect to one another) before the sheathing 22 is fastened, the sheathing may not be installed onto the frame correctly, and the resulting wall panel may be crooked and therefore, rejected. The queueing and squaring table 40 of the present disclosure may be utilized at both the tacking station 20 and the sheathing station 30, as shown for example in FIG. 4. It will be appreciated that the terms “table,” “queueing table,” “squaring table,” and “queueing and squaring table” are used interchangeably herein, and that in some cases, a table disclosed in accordance with the present disclosure may be configured to provide only the function of queueing multiple wall panels on the same table while a manufacturing step is being performed on one of the wall panels, or to only provide the function of squaring a wall panel prior to performing a manufacturing step on that wall panel. In other embodiments, a table disclosed herein may be configured to provide both queueing and squaring functions. While the example embodiments described herein, and shown in the Figures, are typically configured to perform both squaring and queueing functions, it will be appreciated that such tables may also be utilized for queueing functions alone or squaring functions alone.

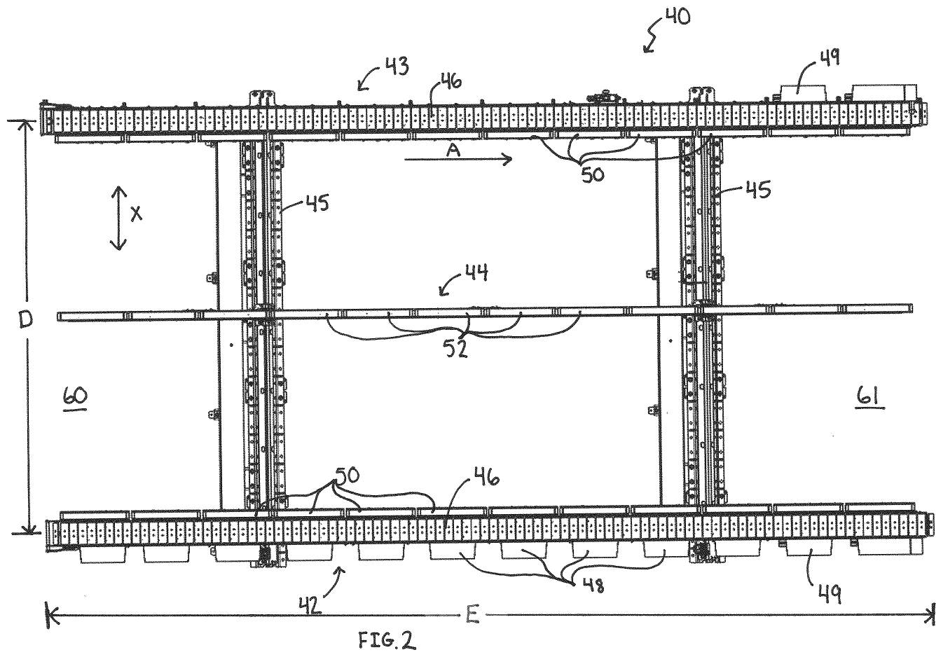

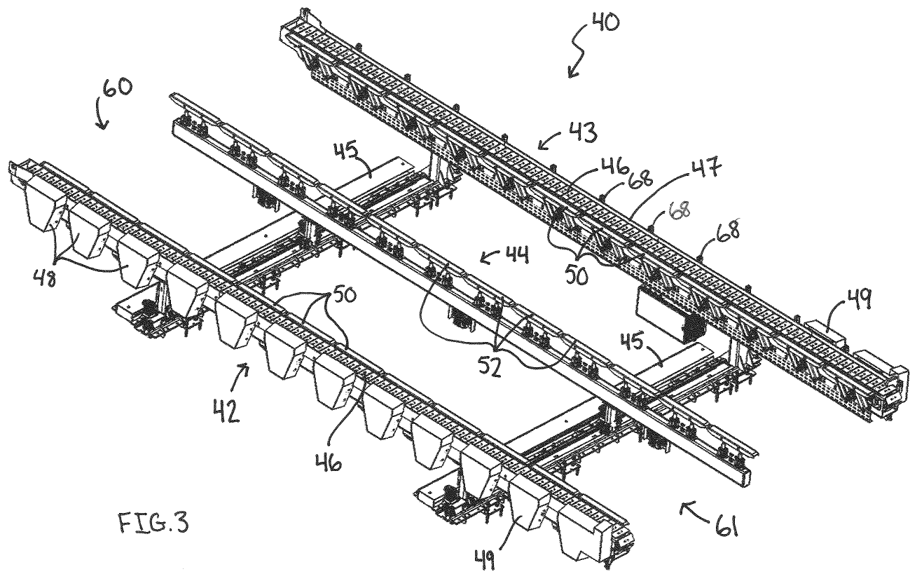

Referring to FIGS. 2 to 8, an embodiment of a squaring table 40 is illustrated. The squaring table 40 comprises first and second conveyor assemblies 42, 43 and optionally may comprise a central support 44 positioned therebetween. Each conveyor assembly 42, 43, comprises a conveyor 46 for conveying the wall panels in direction A. The first and second conveyor assemblies 42, 43 define an entrance end 60 and an exit end 61 of the squaring table 40, such that a wall panel is received onto the squaring table 40 at the entrance end 60, is conveyed along the table 40 in direction A via the conveyors 46, 46 of the conveyor assemblies 42, 43, and exits the squaring table 40 at the exit end 61.

Optionally, the first conveyor assembly 42 or the second conveyor assembly 43 may be mounted to a pair of rails 45, 45, for adjusting the distance D between the first conveyor assembly 42 and the second conveyor assembly 43, for example, by moving the first conveyor assembly 42 in direction X along the rails 45, 45. The optional feature of the adjusting the distance the between the first and second conveyor assemblies 42, 43, is to accommodate for different wall heights H, which may, for example, range between 2 feet and 16 feet.

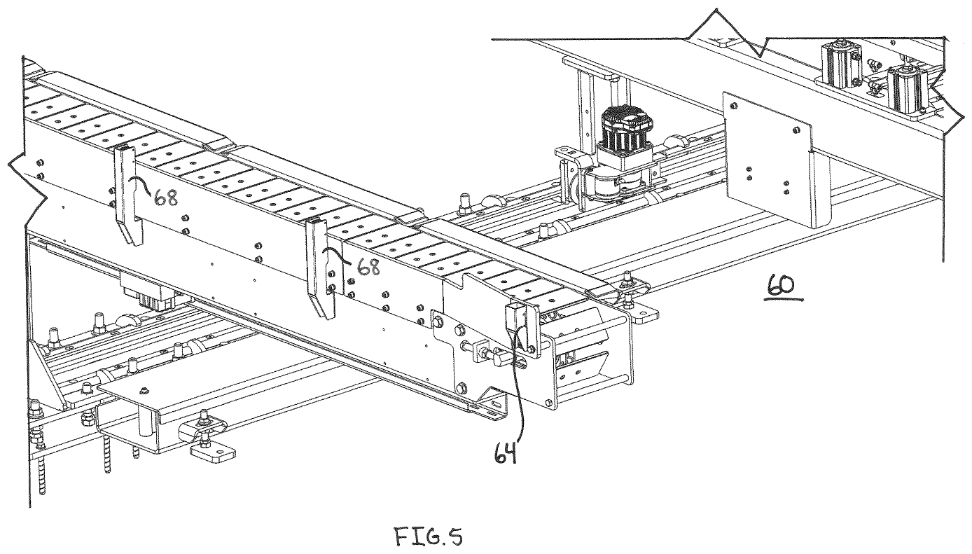

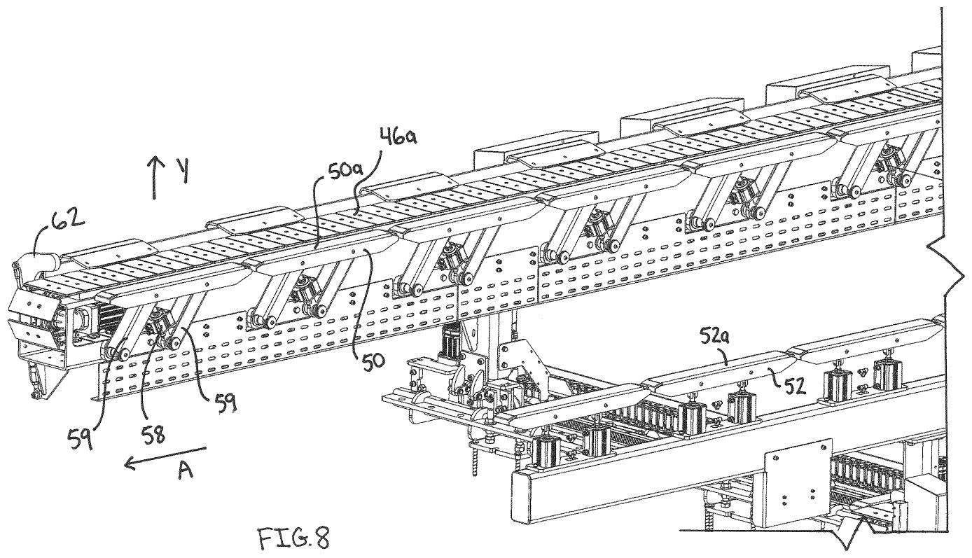

Each conveyor assembly 42, 43 additionally comprises a exit clamp 49 and a plurality of segmented lifts 50. For embodiments including a central support 44, the central support 44 may also comprise a plurality of segmented lifts 52. In a preferred embodiment the first conveyor assembly 42 comprises a plurality of segmented clamps 48. The plurality of segmented clamps 48 may be spaced apart from one another at regular intervals, and may each have a length F for clamping a portion of the plate 14 or 16 of a wall panel frame 12. The plurality of segmented clamps 48 may preferably be positioned along the entire length E of the squaring table 40. In some embodiments, each clamp 48 of the plurality of segmented clamps may have a length F that is equal to the length F of each of the other segmented clamps 48 (see FIG. 8). Likewise, in some embodiments, the length G of each segmented lift 50 or 52 may be equal to the length G of each of the other segmented lifts 50 or 52 (see FIG. 5). In some embodiments, not intended to the limiting, the length G of each segmented lift 50 or 52 may be approximately two feet. Configuring each segmented lift 50 or 52 to have a length G of two feet (for example) allows for efficient calculation of the number of segmented lifts 50 or 52 required to support a give wall panel, as, for example, the wall panels may have a length L of two feet, four feet, six feet, eight feet, etc. It will be appreciated, however, that the discussion herein of the dimensions of the segmented lifts 50, 52 and the clamps 49, 48 is not intended to be limiting, and is merely provided as illustrative examples of the embodiments described herein.

The plurality of segmented lifts 50, on each of the conveyor assemblies 42, 43, may be adjacent to one another, as shown in FIGS. 2 to 8, or alternatively they may be spaced apart from each other to create gaps between the segmented lifts 50. Preferably, the segmented lifts 50 are also positioned at regular intervals along the entire length E of the squaring table 40. Furthermore, there is preferably a segmented lift 50 on each of the first and second conveyor assemblies 42, 43 which corresponds to one of the plurality of segmented clamps 48, as well as a pair of segmented lifts 50 on each of the first and second conveyor assemblies 42, 43 that corresponds with the exit clamps 49, 49, as best viewed for example in FIG. 2.

Optionally, the squaring table 40 may also include a plurality of segmented lifts 52 placed at regular intervals along the central support 44. Preferably, for embodiments including a central support 44, there is a segmented lift 52 which is aligned with and corresponds to the pair of exit clamps 49 and the corresponding pair of lifts 50 on the first and second conveyor assemblies 42, 43. Furthermore, in a preferred embodiment, there is also a plurality of segmented lifts 52, wherein each lift 52 is aligned with a corresponding clamp 48 of the plurality of segmented clamps, and a corresponding pair of segmented lifts 50, 50 on the first and second conveyor assemblies 42, 43. Each of the segmented lifts 52 on the central support 44, and the segmented lifts 50 on the first and second conveyor assemblies 42, 43, are normally in a recessed position, such that an engagement surface 50a or 52a is positioned below a conveyor surface 46a of the conveyors 46, 46, as best viewed for example in FIG. 8.

The squaring table includes a length tracking system. In some embodiments, the length tracking system may be a sensor, such as an entrance sensor 64 located at the entrance end 60 of the squaring table 40. In some embodiments, an exit sensor 66 may be located at the exit end 61 of the squaring table 40. In some embodiments, a plurality of sensors 68 may be spaced apart along the length E of the first and/or second conveyor assemblies 42, 43. The sensor measures the length L of the wall panel. For example, any of the sensors 64, 66 or 68 may operate by detecting a presence or absence of a wall panel proximate to the sensor, and in combination with the speed of the conveyors 46, 46 and the time it takes for the wall panel to pass by the sensor 64, 66 or 68, the controller may determine the length L of the wall panel. Advantageously, for embodiments including a plurality of spaced apart sensor 68, if one sensor becomes faulty or provides a faulty reading, the other sensors 68 provide a redundancy reading. The sensor may include, but is not limited to, laser sensors, photoelectric sensors, encoders, ultrasonic sensors, vision sensors, inductive and capacitive sensors, and any other suitable sensor as would be known to a person skilled in the art. Other means for determining the length of the wall panel may include a user input into the control system or the controller, wherein the known or pre-determined lengths L of the wall panels to be manufactured are entered into the control system or controller. Thus, when the wall panel enters the squaring table at the entrance end 60, a signal is delivered by the control system to a local controller on the squaring table, indicating the pre-determined length of the wall panel that is entering the squaring table 40. x

The sensors may provide additional functions on the table. For example, an entrance sensor 64 may detect the presence of a wall panel entering the table, and may be configured to send a signal to the controller to actuate the conveyors 46, 46 to convey the wall panel towards the end stops of the table. In some embodiments, an exit sensor 66 may be configured to detect that a wall panel, on which a manufacturing step has been completed, has been conveyed off of the table and has cleared the end stops, in which case the exit sensor 66 may be configured to send a signal to the controller to return the pair of end stops 62 to their position at the exit end of the table, so that the next subsequent wall panel may be brought into contact with the pair of end stops 62 by the conveyors 46, 46.

In operation, a wall panel advances onto a squaring table 40 at the entrance end 60, with the plates 14, 16 of the wall panel supported on the conveyor surface 46a and moved in direction A by the conveyors 46. The sensor, if present, is in electronic communication with the control system, and the sensor sends a signal to the controller to indicate the measured length L of the wall panel. The local controller on the squaring table then uses the measured length L of the wall panel to determine a contiguous subset of segmented clamps 48 and a contiguous subset of segmented lifts 50 (and if present, the central support segmented lifts 52) that are contiguous with the length L of the wall panel, in order to stabilize, support and manipulate the wall panel on the squaring table 40. Thus, only as many segments of the segmented lifts 50 (and optionally, 52) that are required to support the measured length L of the wall panel, and only as many clamps 48 as are required to clamp the measured length L of the wall panel, are actuated to clamp and lift the wall panel a short distance above the conveyors 46, 46 in direction Y. The remaining segmented lifts 50 (and optionally, 52) and the remaining segmented clamps 48, which are not engaged with the wall panel, are thus available for engaging a subsequent wall panel that may be queued onto the table behind the first, now elevated and clamped, wall panel.

When the wall panel advances in direction A and comes into contact with the end stops 62 at the exit end 61, the contiguous subset of segmented lifts 50, as determined by the controller acting together with the length tracking system, are actuated to lift the wall panel in direction Y so that the wall panel is no longer in contact with the conveyor surface 46a of the conveyors 46, 46. The pair of exit clamps 49, 49 engages the wall panel and pushes the plates 14, 16 of the wall panel in direction A against the end stops 62, and in direction Z against the fence 47 of the second conveyor assembly 43. As best viewed in FIG. 4, a first actuator 54 compresses the clamp 49 against the plate of the wall panel (not shown) and pushes the wall panel in direction Z against the fence 47 (the fence 47 shown in FIG. 2), and a second actuator 56 moves the clamp 49, and the wall panel gripped by clamp 49, in direction A towards the end stop 62. These actions may therefore automatically square the wall panel. As used herein, the concepts of “squaring the wall panel”, “squaring the wall panel frame” or having a “squared wall panel” refer to arranging the studs 18 at substantially 90° angles (or right angles) with respect to the plates 14, 16 of the wall panel frame 12. While described herein that the plates 14, 16 of the wall panel frame 12 are engaged by the conveyors, segmented clamps and segmented lifts, it will be appreciated that the wall panels may be rotated by 90 degrees, such that the outermost studs 18, 18 of the wall panel are in contact with the conveyors 46, clamped by the exit clamps 49 and plurality of clamps 48, and by the segmented lifts 50 of the conveyor assemblies 42, 43.

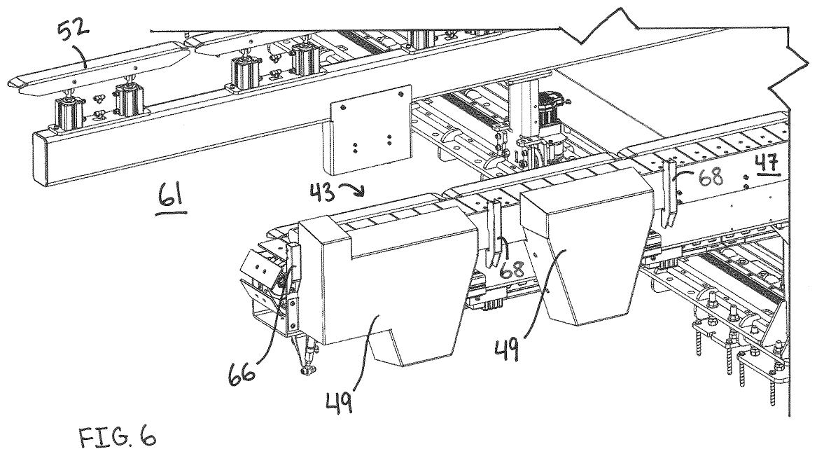

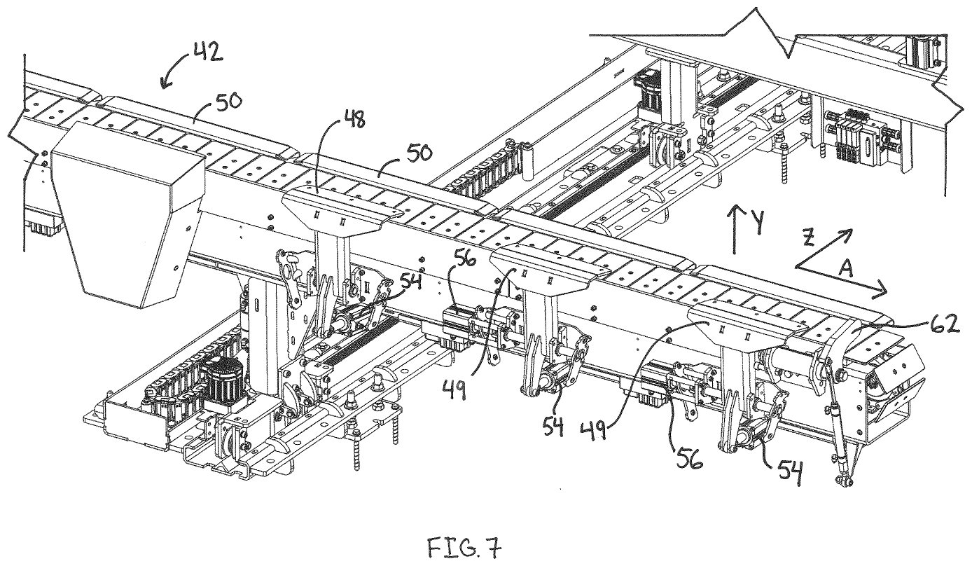

In some embodiments, there may be one pair of exit clamps 49, with one exit clamp 49 located on each of the conveyor assemblies 42, 43, wherein each exit clamp 49 has two actuators 54, 56. The actuator 54 moves the wall panel in direction Z against the fence 47 on the fixed conveyor assembly 43, and actuator 56 moves the wall panel in direction A against the end stops 62, 62. Whereas, the plurality of additional segmented clamps 48 each have only one actuator 54, for moving the wall panel against the fence 47. However, it will be appreciated that some embodiments may have more than one exit clamp 49 on each of the conveyor assemblies 42, 43; for example, in the illustrated embodiments, there are two exit clamps 49, 49 on the first conveyor assembly 42, and two exit clamps 49, 49 on the second conveyor assembly 43 (as best viewed in FIGS. 6 and 7). In some embodiments, there may be two or more exit clamps 49 on each of the first and second conveyor assemblies 42, 43.

In some embodiments, there may be a pressure regulator on some or all of the exit clamps 49, for regulating the pressure applied by the actuators 54 and 56 to the wall panel. For example, after actuators 56 have squared the wall panel against the end stops 62 in direction A, the pressure applied by the actuators 54 may have to be decreased on the exit clamps 49 located on the second conveyor assembly 43, so that these actuators 54 do not counteract the force applied by the lateral actuators 54 on the exit clamps 49 located on the first conveyor assembly 42, when the exit clamps 49 on the second conveyor assembly are acting to push the wall panel against the fence 47, which may for example be located along the conveyor 46 of the second conveyor assembly 43.

When the end stops 62 are fully engaged by the wall panel, as may be detected for example by sensors integrated into the end stops, and/or by an exit sensor 66 located adjacent to or abutting against the end stops 62, the contiguous subset of segmented clamps 48 that are contiguous with the length L of the wall panel, as previously determined by the controller in communication with the sensor or other measuring means, are actuated to clamp the wall panel. While clamped by the subset of contiguous clamp segments 48 and the first and second exit clamps 49, the frame 12 of the wall panel remains squared up against the end stops 62 and the fence 47 during the next manufacturing steps. The fence 47 may have a height of approximately ¾ of an inch (1.9 cm) above the surface 46a of the conveyor 46. Thus, if the segmented lifts 50 raise the wall panel approximately 1/4 of an inch (0.6 cm) above the surface 46a of the conveyors 46, the wall panel remains in contact with, and supported up against, the fence 47. It will be appreciated that the lifting height and the fence height, described herein, are provided as examples only, and that other heights that may be used fall within the scope of the present disclosure.

In some embodiments, there may be two sets of sensors incorporated into the end stops 62 or positioned adjacent to the end stops 62. For example, in such embodiments a first set of sensors may initially detect when the wall panel comes into close proximity to at least one of the end stops 62, and the second set of sensors may detect when the wall panel is in contact with both of the end stops 62, thereby indicating that both sides of the wall panel are fully squared up against both end stops 62. The first and second sets of sensors may be integrated into the end stops 62, and/or the first and second sets of sensors may be located proximate to or adjacent to the end stops 62, such as the exit sensors 66. The first and second sets of sensors may be selected from, but are not limited to, photoelectric sensors, inductive or capacitive sensors, laser sensors, ultrasonic sensors, contact switches, or any other type of sensor or device suitable for detecting the position of each side of the wall panel, relative to the pair of end stops 62, 62, as would be known to a person skilled in the art. In some embodiments, only the first conveyor assembly 42 comprises a plurality of segmented clamps 48 for clamping the wall panel on one side of the panel. Optionally however, in some embodiments the second conveyor assembly 43 may comprise a second plurality of segmented clamps 48, for clamping the wall panel on the other side of the panel.

As best viewed in FIG. 8, the plurality of lifts 50 move the wall panel slightly upwardly in direction Y, for example by approximately ¼ of an inch, so as to temporarily remove the wall panel from contact with the surface 46a of the conveyors 46, so that the conveyors will not continue moving the wall panel in direction A, while at the same time allowing the conveyors 46 to move additional, subsequent wall panels onto the squaring table 40 while a manufacturing step is being performed on the elevated first wall panel, as will be further described below. Optionally, the lifts 50 may also move the wall panel longitudinally in direction A towards the stop 62. In such embodiments, as shown in FIG. 8, the lift actuators 58 may move on a pair of angled linkages 59, 59. The movement of the segmented lifts 50 in direction A additionally assists with shifting the wall panel towards and against the end stops 62 and thereby squaring the frame 12 of the wall panel. However, as previously discussed, the exit clamps 49 utilize the actuator 54 to move the wall panel in direction A, and it is not necessary for the segmented lifts 50 to also move the wall panel in direction A; thus, in other embodiments, the segmented lifts 50 may have actuators that move the segmented lifts vertically in direction Y only, such as the vertical actuators 55 that operate the segmented lifts 52 of the central support 44, best viewed in FIG. 4.

An example of how the squaring tables 40 accomplishes queueing of multiple panels at a given manufacturing station will now be described, with reference in particular to FIG. 1. As best viewed in FIG. 1, utilizing a squaring table 40a at the tacking station 20 and a second squaring table 40b at the sheathing station 30 may advantageously provide for queueing of multiple wall panels on the squaring tables 40a, 40b while the manufacturing steps are being performed simultaneously on one elevated wall panel. In this example, wall panels PA through PE are shown on a manufacturing line 100. A first wall panel PA, measuring eight feet in length L, is positioned under the sheathing gantry 32 at sheathing station 30, and a plurality of nail gun assemblies 35 mounted to the gantry 32 are programmed by the controller to nail the sheathing 22 to the studs 18 of the wall panel PA. The exit clamps 49 and the determined subset of segmented clamps 48 (shown in FIGS. 2 to 8) engage the wall panel PA and move the wall panel PA against the end stops 62, providing that the frame of wall panel PA remains squared during the sheathing operation. At the same squaring table 40b, used at sheathing station 30, a second wall panel PB, measuring eight feet in length L, is queued behind the first wall panel PA. The conveyors 46, 46 are engaged to convey the wall panel PB onto the squaring table 40b while the sheathing operation is being performed on panel PA, because the subset of the plurality of segmented lifts 50 and 52 have lifted panel PA off of the conveyors 46. Thus, conveyors 46 are in contact with, and are moving, panel PB, but not panel PA, at this stage of manufacturing that is illustrated in FIG. 1.

Continuing with the example, a second squaring table 40a is utilized at the tacking station 20. At the tacking station 20, a subset of the plurality of segmented lifts 50 and 52 are engaged to lift the panel PC off of the conveyors 46 of the second squaring table 40a, and the exit clamps 49 have moved the panel PC against the end stops 62 so as to square the frame 12 of wall panel PC. The wall panel PC measures 10 feet in length L. The tacking operation is then performed on panel PC while it is elevated above the conveyors 46 which in the illustrated example may be a manual operation performed by workers on the elevated panel PC. Because panel PC is elevated above the surface 46a of the conveyors 46 by the plurality of segmented lifts 50 and 52, the conveyors 46 are only in contact with the panel PD to advance panel PD in direction A, measuring six feet in length L, onto the second squaring table 40b, while not having any effect on panel PC. At the framing station 10, a squaring table is not utilized, and as may be viewed, the wall panel PE is queued up at the framing station and awaiting advancement onto the tacking station 20. However, this is not intended to be limiting, and a squaring table 40 may also be utilized at framing station 10. Additionally, it should be noted that the manufacturing line 100 may be configured in any number of ways, utilizing squaring and queueing tables 40 at any of the manufacturing stations 10, 20, 30 to perform queueing functions only, or to perform both queueing and squaring functions, and that there may be additional squaring and queueing tables in a manufacturing line, beyond the two squaring and queueing tables 40a, 40b in the illustrated example shown in FIG. 1.

Advantageously, the queueing function of the squaring table 40 may be fully automated, using a plurality of sensors in communication with a controller of the squaring table 40 and a control system for the entire manufacturing line 100. Returning to the example shown in FIG. 1, in some embodiments the squaring tables 40a, 40b may each be provided with an entrance sensor 64 (shown in FIG. 6). Because the length L of each of the wall panels PA to PE has been determined by the controller, by any of the means for determining the length L of a wall panel described herein, the controller and control system will determine whether there is sufficient room on the table 40b to receive wall panel PB; and if there is sufficient room to receive wall panel PB, the control system and controllers will activate the conveyors 46 on tables 40a, 40b to move wall panel PB from table 40a to table 40b, while panel PA is elevated above the conveyors 46.

When panel PB enters the squaring table 40b, the entrance sensor 64 is activated, having detected the presence of panel PB, and sends a signal to the controller, causing the controller to actuate the conveyors 46 to move panel PB in direction A. The controller may be configured such that the conveyors 46 continue to move panel PB in direction A until the entrance sensor 64 no longer detects the presence of panel PB, causing the conveyors 46 to stop moving panel PB. At the same time that the conveyors 46 on table 40b are moving at sheathing station 30, the conveyors 46 of table 40a, at tacking station 20, may also be actuated by the control system to advance panels PC and PD in direction A, towards the exit end 61 of table 40a. Likewise, when the entrance sensor 64 no longer detects the presence of panel PB and the controller and control system signals the conveyors 46 of table 40b to stop, at the same time, the control system and controller of table 40a may be configured to stop the conveyors 46 of table 40a at the same time. In this manner, any upstream and/or downstream conveyor apparatuses may be controlled by the same control system to simultaneously move wall panels in direction A, which provides for a more complete utilization of the space available on multiple upstream and/or downstream conveyor apparatuses in the manufacturing line 100. It will also be appreciated that a squaring and/or queueing table may be used in a system with an upstream apparatus and/or a downstream apparatus that does not have its own conveyor. In such cases, the wall panels may be placed manually onto the conveyors 46 of the table at the entrance end of the table 40, and/or they may be removed manually from the conveyors 46 at the exit end of the table 40.

In some embodiments of the present disclosure, a plurality of measuring devices 68 may be positioned along one or both of the conveyor assemblies 42, 43; in the illustrated example shown in FIGS. 2 to 8, a plurality of measuring devices 68 are arranged alongside the conveyor 46 and fence 47 of the conveyor assembly 43. The plurality of measuring devices 68 may be configured to measure the length of each wall panel, with a resolution equal to the spacing between the sensors 68; for example, not intended to be limiting, the spacing between sensors 68 may be two feet (60 cm). The sensors 68 may be configured to detect the absence or presence of a wall panel. This data, in combination with the speed of the conveyors 46, may be used to determine the length L of each wall panel. Advantageously, having a plurality of sensors 68 provides for redundancy of measurement, in the event of panel slippage on the conveyor chain, objects or dust obscuring or blocking one of the sensors 68, or failure of one of the sensors 68. It will also be appreciated by a person skilled in the art that any other method of measuring the length of a wall panel, as would be known to a person skilled in the art, is intended to be included in the scope of the present disclosure, and that the methods of measuring the length of wall panels, described herein, are not intended to be limiting.

Advantageously, as illustrated in the example of FIG. 1, multiple wall panels PA to PD are queued up at the tacking and sheathing stations 20, 30, and queueing subsequent wall panels behind the elevated wall panels PA and PC may be performed while manufacturing steps are being performed on the elevated wall panels PA and PC. Whereas, in a conventional wall panel manufacturing line, the absence of a mechanism for allowing one panel to be worked upon while continuing to convey additional panels onto the same manufacturing station results in only one wall panel occupying each manufacturing station at a time. Thus, rather than utilizing open space on a given manufacturing station to queue multiple wall panels for the next manufacturing step, it is necessary to provide other means for queueing such wall panels. For example, a conventional manufacturing line may typically include additional conveyors between the framing station 10 and the tacking station 20, and between the tacking station 20 and the sheathing station 30, providing space to queue multiple wall panels awaiting these steps in the manufacturing process. In other conventional manufacturing lines, wall panels may need to be temporarily removed from the line until the next manufacturing station becomes available for use. In some manufacturing lines, if there is no sufficient space provided for queueing wall panels, it may be that a wall panel must remain at an upstream manufacturing station before being sent to the next manufacturing station, awaiting the manufacturing step to be completed on a downstream wall panel. Determining whether there is sufficient space on a squaring and queueing table 40, in some embodiments, may involve the controller, in communication with the sensors and the control system and utilizing the measured length of each wall panel and the position of each wall panel in the system, determining that the length of the table 40 and the length of the first wall panel adjacent to the exit end 61 of the table 40, provides sufficient free space upstream of the first wall panel on the table 40 to fit the subsequent wall panel, taking into account the length E of the table 40 and the length L of the subsequent wall panel.

As an illustrative example, referring again to FIG. 1, if the squaring tables 40a, 40b at the tacking and sheathing stations 20, 30 were using conventional tables without the innovations that are described herein, and if there were no additional conveyors positioned between each manufacturing station, it may be that panel PB is held at the tacking station 20 while the sheathing manufacturing step is completed on panel PA at the sheathing station 30. In such a scenario, likewise, panel PC may be held at the framing station 10 while awaiting the sheathing manufacturing step to be completed on panel PA at the sheathing station 30. In this hypothetical scenario, the wall panels PD and PE may be held further upstream of framing station 10. Thus, it may be appreciated that the squaring tables 40 disclosed herein provide for a more compact manufacturing line for manufacturing wall panels, and increase the overall efficiency of the manufacturing process while reducing the time required to complete manufacture of a wall panel.

It will be appreciated that the squaring table innovations disclosed herein may be utilized at other stations on a manufacturing line for wall panels. For example, the novel squaring and queueing functions disclosed herein may be utilized at the framing station, where the frame 12 of the wall panel is constructed before the sheathing is applied. As another example, the queueing function (ie: a table with first and second conveyor assemblies 42, 43, each conveyor assembly having a plurality of segmented lifts 50, 52 and a plurality of segmented clamps 48) may be utilized at some manufacturing stations, whether or not the squaring function of the table is required. For example, the queueing function may be utilized at a station where insulation or electrical wiring is installed inside the wall panel, or at a station where cutouts in the sheathing are prepared for window and door frames in the wall panel, and so forth. In all such cases, depending on the configuration of the manufacturing line, it may be useful to have a table 40 providing a queueing function, wherein multiple wall panels of varying lengths may be queued at a given table, while at the same time a manufacturing step is being performed on one of the wall panels at the station. It will be apparent to a person skilled in the art that other variations on the queueing and squaring functions, described herein, are intended to be included in the present disclosure.

What is claimed is:

1. A table for squaring a wall panel and for queueing a plurality of wall panels at a manufacturing station, each wall panel of the plurality of wall panels comprising an upper plate, a lower plate, a plurality of studs extending between the said upper and lower plates and a sheathing, the table comprising:
opposite first and second spaced apart conveyor assemblies for conveying each wall panel of the plurality of wall panels, the first and second conveyor assemblies defining an entrance end and an opposite exit end of the table;
the first conveyor assembly comprising a first conveyor, a first exit clamp located at the exit end of the table, a plurality of segmented clamps and a first plurality of segmented lifts;
the second conveyor assembly comprising a second conveyor, a second exit clamp located at the exit end of the table and a second plurality of segmented lifts;
a length tracking system for tracking a length of each wall panel of the plurality of wall panels passing through the table;
a pair of end stops located at the exit end of the table;
a controller in communication with the first and second conveyors, the first and second exit clamps, the plurality of segmented clamps, the first and second plurality of segmented lifts, the length tracking system and the pair of end stops;
wherein the first and second exit clamps cooperate with the controller to initially clamp a first wall panel of the plurality of wall panels and move the first wall panel against the pair of end stops to square the first wall panel;
wherein the controller and the length tracking system determine a length of the first wall panel;
wherein the controller engages only a corresponding contiguous subset of clamps of the plurality of segmented clamps to clamp the length of the first wall panel and engages only a corresponding contiguous first subset of lifts of the first and second pluralities of segmented lifts to elevate the length of the first wall panel above the first and second conveyors so that the first wall panel is not in contact with the first and second conveyors; and
wherein the first and second conveyors advance one or more subsequent wall panels of the plurality of wall panels onto the table when the first wall panel is elevated above the first and second conveyors.

2. The table of claim 1 wherein one conveyor assembly of the first and second conveyor assemblies is slidably mounted to a rail, the rail located perpendicular to the first and second conveyors, and wherein the one conveyor assembly may be selectively repositioned relative to the other conveyor assembly so as to configure a width of the table for conveying wall panels of different heights.

3. The table of claim 1 further comprising a central support located between and parallel to the first and second conveyor assemblies, the central support comprising a third plurality of segmented lifts, wherein the controller engages only a corresponding contiguous second subset of lifts of the third plurality of segmented lifts, corresponding to the first subset of lifts, to support and elevate a central portion of the first wall panel.

4. The table of claim 3 wherein the central support is slidably mounted to a rail, the rail located perpendicular to the central support, and wherein the central support may be selectively repositioned relative to the first and second conveyor assemblies so as to configure the position of the central support relative to the first wall panel.

5. The table of claim 1 wherein a manufacturing step is performed on the first wall panel when the first wall panel is elevated above the first and second conveyors.

6. The table of claim 1 wherein the first and second exit clamps each comprise a longitudinal actuator for moving the exit clamp and the first wall panel in a longitudinal direction against the pair of end stops, and a lateral actuator for moving the first exit clamp and the first wall panel in a lateral direction towards and against a fence, the fence adjacent to the second conveyor.

7. The table of claim 6 wherein each of the first and second exit clamps includes a pressure regulator, each pressure regulator for regulating a pressure applied to the first wall panel by the corresponding exit clamp when the first exit clamp utilizes the lateral actuator to move the first wall panel against the fence.

8. The table of claim 1 wherein each end stop of the pair of end stops includes integrated sensors integrated into each end stop, the integrated sensors for detecting that the first wall panel is pushed against both end stops of the pair of end stops.

9. The table of claim 1 wherein the length tracking system is a sensor selected from a group comprising: laser sensors, photoelectric sensors, encoders, ultrasonic sensors, vision sensors, inductive sensors, capacitive sensors.

10. The table of claim 9 wherein the sensor is an entrance sensor is located at the entrance end of the table.

11. The table of claim 9 wherein the sensor comprises a plurality of sensors, the plurality of sensors positioned spaced apart from one another along, and adjacent to, at least one conveyor of the first and second conveyors, and wherein the controller determines the length of each wall panel by detecting a presence or absence of each wall panel by each sensor and determining the time and speed of travel of each wall panel conveyed by the first and second conveyors.

12. The table of claim 1 wherein the length tracking system is a user input into the controller, the user input comprising a length of each wall panel and a sequence of each wall panel of the plurality of wall panels to be passed through the table.

13. The table of claim 10 wherein when the entrance sensor detects a subsequent wall panel and the controller indicates there is an available space on the table, the first and second conveyors are activated by the controller to convey the subsequent wall panel onto the table until the subsequent wall panel is adjacent to an elevated pair of segmented lifts of the first subset of lifts; and
wherein the length determining means determines the length of the subsequent wall panel and the controller engages only a corresponding contiguous second subset of clamps of the plurality of segmented clamps to clamp the length of the subsequent wall panel and engages only a corresponding contiguous second subset of lifts of the first and second pluralities of segmented lifts to elevate the subsequent wall panel above the first and second conveyors so that the subsequent wall panel is not in contact with the first and second conveyors.

14. A method of queueing a plurality of wall panels on a wall panel assembly line, the wall panel assembly line comprising a queueing table and at least one of an upstream apparatus located upstream of the queueing table and a downstream apparatus located downstream of the queueing table, the method comprising:
receiving a first wall panel on the queueing table, the queueing table comprising:
opposite first and second spaced apart conveyor assemblies for conveying each wall panel of the plurality of wall panels, the first and second conveyor assemblies defining an entrance end and an opposite exit end of the queueing table;
the first conveyor assembly comprising a first conveyor, a first exit clamp located at the exit end of the queueing table, a plurality of segmented clamps and a first plurality of segmented lifts;
the second conveyor assembly comprising a second conveyor, a second exit clamp located at the exit end of the queueing table and a second plurality of segmented lifts;
a length tracking system for tracking a length of each wall panel of the plurality of wall panels passing through the queueing table;
a pair of end stops located at the exit end of the queueing table;
a controller in communication with the first and second conveyors, the first and second exit clamps, the plurality of segmented clamps, the first and second plurality of segmented lifts, the length tracking system and the pair of end stops;
actuating the first and second conveyors to convey the first wall panel towards, so as to abut against, the pair of end stops;
determining, by the length tracking system and the controller, the length of the first wall panel;
engaging, by the controller, only a corresponding contiguous subset of clamps of the plurality of segmented clamps to clamp the length of the first wall panel and only a corresponding contiguous first subset of lifts of the first and second pluralities of segmented lifts to elevate the length of the first wall panel above the first and second conveyors so that the first wall panel is not in contact with the first and second conveyors;
determining, by the controller, whether there is space available on the queueing table to receive a subsequent wall panel from the upstream apparatus, and if there is space available on the queueing table, actuating the first and second conveyors to convey the subsequent wall panel received from the upstream apparatus towards the elevated first wall panel until the subsequent wall panel is adjacent to a pair of elevated segmented lifts of the first subset of lifts.

15. The method of claim 14 wherein the upstream apparatus is an upstream conveyor in communication with the controller, and wherein when the first and second conveyors of the queueing table are actuated to convey the subsequent wall panel towards the elevated first wall panel, the upstream conveyor is also actuated to convey any wall panels of the plurality of wall panels supported on the upstream conveyor towards the queueing table.

16. The method of claim 14 further comprising that a manufacturing step is performed on the first wall panel when the first wall panel is elevated above the first and second conveyors.

17. The method of claim 16 wherein when the manufacturing step is completed on the first wall panel, the controller:
actuates the first subset of lifts to lower the elevated first wall panel onto the first and second conveyors;
disengages the first and second exit clamps and the subset of segmented clamps from the first wall panel;
retracts the pair of end stops away from the exit end of the queueing table;
actuates the first and second conveyors of the queueing table to convey the first wall panel onto the downstream apparatus and convey any subsequent wall panels towards the pair of end stops;
actuates the pair of end stops into place at the exit end of the queueing table so that the next subsequent wall panel is conveyed towards the pair of end stops until it abuts against the pair of end stops.

18. The method of claim 17 wherein the downstream apparatus is a downstream conveyor in communication with the controller, and wherein when the first and second conveyors of the queueing table are actuated to convey the first wall panel onto the downstream conveyor, the downstream conveyor is also actuated to convey the first wall panel received from the queueing table onto the downstream conveyor.

19. A queueing table for queueing a plurality of wall panels at a manufacturing station, each wall panel of the plurality of wall panels comprising an upper plate, a lower plate and a plurality of studs extending between the said upper and lower plates and a sheathing, the queueing table comprising:
opposite first and second spaced apart conveyor assemblies for conveying each wall panel of the plurality of wall panels, the first and second conveyor assemblies defining an entrance end and an opposite exit end of the queueing table;
the first conveyor assembly comprising a first conveyor, a plurality of segmented clamps and a first plurality of segmented lifts;
the second conveyor assembly comprising a second conveyor and a second plurality of segmented lifts;
a length tracking system for tracking a length of each wall panel of the plurality of wall panels passing through the queueing table;
a pair of end stops located at the exit end of the queueing table;
a controller in communication with the first and second conveyors, the plurality of segmented clamps, the first and second pluralities of segmented lifts, the length tracking system and the pair of end stops;
wherein the controller and the length tracking system determine a length of a first wall panel of the plurality of wall panels;
wherein the controller engages only a corresponding contiguous subset of clamps of the plurality of segmented clamps to clamp the length of the first wall panel and engages only a corresponding contiguous first subset of lifts of the first and second pluralities of segmented lifts to elevate the length of the first wall panel above the first and second conveyors so that the first wall panel is not in contact with the first and second conveyors; and
wherein the first and second conveyors advance one or more subsequent wall panels of the plurality of wall panels onto the queueing table when the first wall panel is elevated above the first and second conveyors.

20. A squaring table for squaring a wall panel at a manufacturing station, each wall panel of the plurality of wall panels comprising an upper plate, a lower plate and a plurality of studs extending between the said upper and lower plates and a sheathing, the squaring table comprising:
first and second spaced apart conveyor assemblies defining an entrance end and an exit end of the squaring table;
the first conveyor assembly comprising a first conveyor;
the second conveyor assembly comprising a second conveyor;
a pair of end stops located at the exit end of the squaring table;
a sensor located at the exit end of the squaring table for detecting the presence of the squaring table against each end stop of the pair of end stops;
a controller in communication with the first and second conveyors, the sensor and the pair of end stops;
wherein when the sensor detects a presence of a first wall panel of the plurality of wall panels, the first and second conveyors continue conveying the wall panel so as to engage the wall panel against both end stops of the pair of end stops so as to square the first wall panel.

21. The squaring table of claim 20 further comprising a first exit clamp of the first conveyor assembly and a second exit clamp of the second conveyor assembly, the first and second exit clamps located at the exit end of the squaring table, wherein when the wall panel is abutting against both the end stops of the pair of end stops, the first and second exit clamps clamp the wall panel while a manufacturing step is performed on the wall panel.

22. The squaring table of claim 21 wherein the first and second exit clamps each comprise a longitudinal actuator for moving the exit clamp and the first wall panel in a longitudinal direction against the pair of end stops, and a lateral actuator for moving the first exit clamp and the first wall panel in a lateral direction towards and against a fence, the fence adjacent to the second conveyor.

23. The squaring table of claim 22 wherein each of the first and second exit clamps includes a pressure regulator, each pressure regulator for regulating a pressure applied to the first wall panel by the corresponding exit clamp when the first exit clamp utilizes the lateral actuator to move the first wall panel against the fence.

24. The squaring table of claim 20 wherein the sensor is selected from a group comprising: one or more exit sensors located adjacent to the pair of end stops, integrated sensors integrated into each end stop.
